(19) United States
(12) Patent Application Publication
(10) Pub. No.: US 2015/0118452 A1
(43) Pub. Date: Apr. 30, 2015

(54) INK JET INK COMPOSITION, RECORDING METHOD, AND RECORDED MATTER

(71) Applicant: Seiko Epson Corporation, Tokyo (JP)

(72) Inventors: Masakazu Ohashi, Shiojiri (JP); Toru Saito, Yamagata (JP)

(21) Appl. No.: 14/521,773

(22) Filed: Oct. 23, 2014

(30) Foreign Application Priority Data
Oct. 25, 2013 (JP) 2013-221952

(51) Int. Cl. C09D 11/36; C08K 5/3417; C08K 5/17; C08K 5/5419; C08K 5/053; C08K 5/06; C09D 175/04; C08K 3/22

(52) U.S. Cl. CPC C09D 11/36; C09D 175/04; C08K 5/3417; C08K 3/22; C08K 5/5419; C08K 5/053; C08K 5/06; C08K 5/17; C08K 2003/2241
USPC 428/196; 524/88; 524/267; 347/20; 428/207

(57) ABSTRACT

An ink jet ink composition includes one or more kinds selected from a group formed of a pigment and a resin dispersion, and one or more alkali components selected from a group formed of metal alkali and organic alkali, in which a pH of the ink jet ink composition is 8.5 to 10.4 and a pH of an extract of a recorded matter for a test in which the ink jet ink composition is attached to a recording medium is 4.0 to 7.5.

### BACKGROUND

1. Technical Field

The present invention relates to an ink jet ink composition, a recording method using the ink jet ink composition, and a recorded matter obtained by the ink jet ink composition.

2. Related Art

In an ink jet recording method, a high-resolution image can be recorded with a relatively simple apparatus, and rapid development has been achieved in various fields. Among these, various studies have been made for the ink jet recording method used with respect to fabric. For example, JP-A-2004-83688 discloses an color ink set including a black ink and color inks other than the black ink, in which the black ink includes a black pigment, resin particles having carboxyl groups, a first pH adjusting agent, a water-soluble organic solvent, and water, and the pH is 8 or greater, the color ink includes a coloring pigment, acryl-based resin particles, a second pH adjusting agent, a water-soluble organic solvent, and water, and the pH is 4.5 or less, to provide an ink set by which the initial image density is maintained without losing the ink from the image forming material, even if an image forming material such as cloth is washed.

In recent years, in the Oeko-Tex Standard 100 enacted by the Oeko-Tex Association, the pH of the extract of the fiber product has been required to be in a predetermined range. However, in the ink set disclosed in JP-A-2004-83688, an ink composition of which the pH is 8 or greater and an ink composition of which the pH is 4.5 or less are used in combination, and thus, it is difficult to make the pH of the extract of the finally obtained fiber product be within the predetermined standard range, and safety is poor when being used for clothes.

In addition, when the pH of the ink composition is excessively basic or excessively acidic, clogging occurs in the ink jet head (hereinafter, simply referred to as “head”) or degradation of a member of a recording apparatus occurs.

### SUMMARY

An advantage of some aspects of the invention is to provide an ink jet ink composition which can prevent head clogging and degradation of the member of the recording apparatus and gives a recorded matter which satisfies the Oeko-Tex Standard, a recording method using the ink jet ink composition, and a recorded matter obtained by the ink jet ink composition.

The present inventors control the pH of the ink jet ink composition having a predetermined composition so as to be in the predetermined range, thereby completing the invention.

That is, the invention is as follows.

[1] An ink jet ink composition including one or more kinds selected from a group formed of a pigment and a resin dispersion and one or more alkali components selected from a group formed of metal alkalis and organic alkalis, in which the pH of the ink jet ink composition is 8.5 to 10.4 and the pH of an extract of a recorded matter for a test in which the ink jet ink composition is attached to a recording medium is 4.0 to 7.5.

[2] The ink jet ink composition according to [1], in which the metal alkali is one or more kinds selected from a group formed of potassium hydroxide, sodium hydroxide, and lithium hydroxide, and the organic alkali is one or more kinds selected from a group formed of triethanolamine and triethylamine.

[3] The ink jet ink composition according to [1] or [2], which is used in a recording method including drying the recorded matter at 100° C. or higher.

[4] The ink jet ink composition according to any one of [1] to [3], in which the recording medium is texture of textile or a knitting.

[5] The ink jet ink composition according to any one of [1] to [4], in which the alkali component includes the metal alkali.

[6] The ink jet ink composition according to any one of [1] to [5], in which the pH of the ink jet ink composition is 8.7 to 9.5.

[7] The ink jet ink composition according to any one of [1] to [6], in which the recording medium is clothes.

[8] The ink jet ink composition according to [7], in which the clothes are clothes for infants or clothes which come into direct contact with human skin when being worn.

[9] A recording method having attaching an ink jet ink composition according to any one of [1] to [8] to a recording medium by discharging from an ink jet nozzle.

[10] A recorded matter which is recorded by attaching an ink jet ink composition according to any one of [1] to [8] to a recording medium.

### DESCRIPTION OF EXEMPLARY EMBODIMENTS

Hereinafter, embodiments for carrying out the invention (hereinafter, referred to as “the embodiment”) will be described in detail. Furthermore, the invention is not limited thereto, and various modifications are possible without departing from the gist of the invention.

### Ink Jet Ink Composition

The ink jet ink composition (hereinafter, also referred to as “the ink composition”) according to the embodiment includes one or more selected from a group formed of a pigment and a resin dispersion and one or more alkali components selected from a group formed of metal alkali and organic alkalis, in which the pH of the ink jet ink composition is 8.5 to 10.4 and the pH of an extract of a recorded matter for a test in which the ink jet ink composition is attached to a recording medium is 4.0 to 7.5.

### pH of Ink Jet Ink Composition

The pH of the ink jet ink composition is 8.5 to 10.4, and preferably 8.7 to 9.5. When the pH of the ink jet ink composition is 8.5 or greater, since resolubility of the pigment or the resin dispersion in the ink composition is excellent, the pigment or the resin dispersion can be redissolved even if these are separated during being left as is, and thus it is possible to further prevent clogging of nozzles. In addition, when the pH of the ink jet ink composition is 10.4 or less, it is also possible to further prevent degradation of the member (adhesive of a head or the like) of the recording apparatus. Moreover, the pH of the ink jet ink composition can be measured by the method described in the examples.

The pH of the ink jet ink composition can be controlled by the pigment, the resin dispersion, and the kind and the content of the alkali component.

### pH of Extract

The pH of the extract of the recorded matter for a test in which the ink jet ink composition is attached to the recording medium is 4.0 to 7.5. When the pH of the extract is in the above-described range, it is possible to satisfy the Oeko-Tex Standard, and it is possible to obtain a recorded matter with superior safety. Moreover, the pH of the extract can be measured by the method described in the examples. Moreover, it is considered that a part of components of the ink coating film attached to the recording medium and dried is extracted into the extract, and thus, the pH of the extract does not simply correspond to the pH of the ink composition.

The pH of the extract can be controlled by the pigment, the resin dispersion, and the kind and the content of the alkali component. In particular, there is a tendency that it is possible to control the pH of the extract to be close to the pH of the ink jet ink composition by using an organic alkali. Moreover, “the pH of the extract of the recorded matter for a test” can be determined by the method described in the examples.

The difference between the pH of the ink jet ink composition and the pH of the extract is preferably 1 to 4, more preferably 2 to 4, and even more preferably 2.5 to 4. When the difference between the pH of the ink jet ink composition and the pH of the extract is in the above-described range, there is a tendency that it is possible to prevent head clogging and degradation of the member of the recording apparatus, and it is possible to further reduce the pH of the extract.

### Pigment and Resin Dispersion

The ink jet ink composition according to the embodiment includes one or more selected from a group formed of the pigment and the resin dispersion, and preferably includes both the pigment and the resin dispersion. The pigment and the resin dispersion ensure dispersion stability by partially neutralizing an acidic material using alkali. Therefore, it is important to control the pH of the ink jet ink composition and the pH of the extract by combining one or more selected from a group formed of the pigment and the resin dispersion with the alkali component and adjusting the kinds or the contents thereof.

### Pigment

As the pigment, an inorganic pigment and an organic pigment can be exemplified, and preferably used as a coloring material. Examples of the inorganic pigment, which are not particularly limited, include carbon blacks such as a furnace black, a lamp black, an acetylene black and a channel black (C.I. Pigment Black 7), iron oxide and titanium oxide.

Examples of the organic pigment, which are not particularly limited, include a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perynone-based pigment, a quinophthalone-based pigment, an anthraquinone-based pigment, a thioindigo-based pigment, a benzimidazolone-based pigment, an isoindolinone-based pigment, an azomethine-based pigment, and an azo-based pigment.

The pigment may be used alone as one kind or may be used in a combination of two or more kinds, and may be used in a state of the pigment dispersion in which the pigment was dispersed.

The content of the pigment (solid content) is preferably 0.5% by mass to 15% by mass, more preferably 1% by mass to 13% by mass, and even more preferably 2% by mass to 10% by mass with respect to the total mass (100% by mass) of the ink composition. When the content of the pigment is in the above-described range, there is a tendency that a recorded matter having excellent coloring properties is obtained. Moreover, in a case where the pigment is a white pigment such as titanium oxide, the content is preferably 5% by mass or greater, and more preferably 7% by mass or greater to increase concealing properties of the recorded matter.

### Resin Dispersion

There is a tendency that by including the resin dispersion, since when the ink composition is dried, the resins, and the resin and the pigment are fused together, the pigment is fixed on the fabric or a resin film is fixed on the fabric, the friction resistance and the washing fastness of an image portion of the recorded matter become more excellent.

The resin dispersion is not particularly limited as long as it is a resin dispersion in which the resin is dispersed in a dispersion medium as fine particles, and examples thereof include a dispersion, a suspension, and an emulsion.

Examples of the resin dispersion, which are not particularly limited, include emulsions of urethane resins represented by a polyether-type urethane resin, a polyester-type urethane resin including an ester bond in the main chain, or a polycarbonate-type urethane resin including a carbonate bond in the main chain, and a (meth)acrylic resin emulsion, and a styrene-(meth)acrylic acid copolymer-based resin emulsion. Moreover, the above-described copolymers may be any form of a random copolymer, a block copolymer, an alternating copolymer and a graft copolymer.

The resin dispersion may be used alone as one kind or may be used in a combination of two or more kinds.

The content of the resin dispersion (solid content) is preferably 2% by mass to 20% by mass, more preferably 3% by mass to 16% by mass, and even more preferably 4% by mass to 15% by mass with respect to the total mass (100% by mass) of the ink composition. When the content of the resin dispersion is in the above-described range, there is a tendency that the washing fastness and the friction resistances of a recorded matter are excellent, the long-term storage stability of the ink composition is excellent, and the viscosity of the ink composition can be lowered. Moreover, in a case where the pigment is a white pigment such as titanium oxide, the content of the resin dispersion (solid content) is preferably 5% by mass or greater, and more preferably 7% by mass or greater.

In a case of including both the pigment and the resin dispersion, the content of the pigment (solid content) and the resin dispersion (solid content) is preferably 2.5% by mass to 35% by mass, more preferably 4% by mass to 29% by mass, and even more preferably 6% by mass to 25% by mass with respect to the total mass (100% by mass) of the ink composition. When the content of the pigment and the resin dispersion is in the above-described range, there is a tendency that a recorded matter having excellent coloring properties is obtained, and the friction resistance and the washing fastness of an image portion of the recorded matter become more excellent.

### Alkali Component

The ink jet ink composition according to the embodiment includes one or more selected from a group formed of metal alkalis and organic alkalis, and preferably includes both a metal alkali and an organic alkali. By including at least one or more of the metal alkalis and the organic alkalis, clogging of a head is further suppressed.

### Metal Alkali

The alkali component preferably includes a metal alkali. By including the metal alkali, controllability of the pH of the extract is more excellent. The metal alkali is not particularly limited as long as it is an alkali component having a metal element, metal hydroxides can be exemplified, and more specifically, one or more selected from a group formed of potassium hydroxide, sodium hydroxide, and lithium hydroxide can be preferably exemplified from the viewpoint of controllability of the pH. The metal alkalis may be used alone as one kind or may be used in a combination of two or more kinds.

The content of the metal alkali is preferably 0.01% by mass to 0.5% by mass, more preferably 0.02% by mass to 0.30% by mass, and even more preferably 0.02% by mass to 0.10% by mass with respect to the total mass (100% by mass) of the ink composition. When the content of the metal alkali is in the above-described range, controllability of the pH of the extract tends to be more excellent.

### Organic Alkali

The alkali component preferably includes an organic alkali. The organic alkali is not particularly limited as long as it is an alkali component which is an organic compound, and ammonia and amine compounds can be exemplified, and more specifically, one or more selected from a group formed of ammonia, triethanolamine, and triethylamine can be preferably exemplified from the viewpoint of controllability of the pH. The organic alkalis may be used alone as one kind or may be used in a combination of two or more kinds.

The content of the organic alkali is preferably 0.01% by mass to 1.50% by mass, more preferably 0.05% by mass to 1.0% by mass, and even more preferably 0.10% by mass to 0.80% by mass with respect to the total mass (100% by mass) of the ink composition. When the content of the organic alkali is in the above-described range, controllability of the pH of the extract tends to be more excellent.

In a case of including both the metal alkali and the organic alkali, the content of the metal alkalis and the organic alkalis is preferably 0.01% by mass to 1.00% by mass, more preferably 0.05% by mass to 0.90% by mass, and even more preferably 0.10% by mass to 0.80% by mass with respect to the total mass (100% by mass) of the ink composition. When the content of the metal alkalis and the organic alkalis is in the above-described range, controllability of the pH of the extract tends to be more excellent.

### Other Additives

The ink composition according to the embodiment may include other additives, if necessary. Examples of other additives, which are not particularly limited, include water, solvents other than water, a penetrating agent, a moisturizing agent, a surfactant, a pH adjusting agent, a solubilizer, a viscosity modifier, an antioxidant, a preservative, an antifungal agent, a corrosion inhibitor, and a chelating agent for capturing metal ions which affect dispersion.

### Applications

The ink composition according to the embodiment is preferably an ink jet ink composition for clothes, more preferably for clothes for infants, or clothes which come into direct contact with human skin when being worn. More specifically, the ink composition is preferably for recorded matters corresponding to “Product category I for infants (under 36 months)” and “Product category II large skin contact (underwear or the like)” stipulated in the Oeko-Tex Standard 100-2013. In the classification of the Oeko-Tex Standard 100-2013, there are “Product category I for infants (under 36 months)”, “Product category II large skin contact (underwear or the like)”, “Product category III small skin contact (outerwear or the like)”, and “Product category IV for ornament (interior). Among these, pH values (hydrogen ion exponent) of “Product category I for infants (under 36 months)” and “Product category II large skin contact (underwear or the like)” are stipulated as 4.0 to 7.5. Moreover, pH values in the Oeko-Tex Standard 100-2013 are measured based on the Oeko-Tex Standard. Moreover, pH values in the Oeko-Tex Standard 100-2013 are measured according to ISO 3071 (KCl solution). The measurement of the pH value can also be performed in the general incorporated foundation Nissenken Quality Evaluation Center which is a certification authority.

Since in application for clothes which come into direct contact with human skin when being worn, it is required that higher safety standards are satisfied, a new problem that composition and physical properties of the ink jet ink composition are subjected to certain restriction to satisfy the safety standards occurs. The ink composition according to the embodiment includes one or more selected from a group formed of a pigment and a resin dispersion and one or more alkali components selected from a group formed of metal alkalis and organic alkalis, and by adjusting the pH of the ink jet ink composition to be 8.5 to 10.4 and the pH of an extract of a recorded matter for a test obtained by attaching to a recording medium to be 4.0 to 7.5, the ink jet ink composition can be suitably used for applications to obtain a recorded matter which satisfies higher safety standards.

In addition, the ink jet ink composition according to the embodiment is preferably an ink composition which is used in a recording method including a drying step of drying a recorded matter to be obtained at 100° C. or higher. Even when used for such an application, it is possible to obtain a recorded matter which satisfies higher safety standards from the ink composition according to the embodiment.

Furthermore, a recording medium in a recorded matter or a recorded matter for a test is preferably fabrics, and among these, the recording medium is preferably texture of textile or knitting of cotton or a polyester material. Since by using texture of textile or knitting, ink is easily fixed to texture while the ink penetrates, the invention is particularly useful.

### Recording Method

The recording method according to the embodiment has an attaching step of attaching the above-described ink jet ink composition to a recording medium by discharging from an ink jet nozzle. The recording method according to the embodiment preferably further includes a drying step of drying the recorded matter obtained in the attaching step.

In the drying step, the water and the solvent component in the ink jet ink composition are evaporated, and fixation to texture is performed by drying the pigment and the resin. From this point of view, the temperature of the drying step is preferably 50° C. or higher, more preferably 80° C. or higher, even more preferably 100° C. or higher, and particularly preferably 110° C. or higher. The upper limit of the temperature, which is not particularly limited, is preferably 200° C. or lower, more preferably 190° C. or lower, and even more preferably 180° C. or lower. The time of the drying step is preferably 20 seconds to 10 minutes, and more preferably 30 seconds to 100 seconds. When the temperature and the time of the drying step is in the above-described range, there is a tendency that fixation to texture and drying are excellent, and drying can be performed in a short time without burning the texture or the printing coating film.

### Recording Medium

As the recording medium, which is not particularly limited, for example, fabric represented by texture of textile or knitting is preferable. In addition, as the raw material of the fabric, which is not particularly limited, natural fibers or synthetic fibers such as silk, cotton, wool, nylon, polyester and rayon are exemplified.

### Recorded Matter

The recorded matter according to the embodiment is a recorded matter recorded by attaching the above-described ink jet ink composition to a recording medium. As the recorded matter, which is not particularly limited, clothes are preferable. As the clothes, which are not particularly limited, clothes for infants or clothes used in contact with skin are preferable. More specifically, the recorded matter according to the embodiment is preferably a recorded matter corresponding to “Product category II for infants (under 36 months)” and “Product category II large skin contact (underwear or the like)” stipulated in the Oeko-Tex Standard 100-2013.

### EXAMPLES

Hereinafter, the invention will be more specifically described using Examples and Comparative Examples. The invention is not limited to these following Examples.

### Material for Ink Composition

The main materials for the ink composition used in the following Examples and Comparative Examples are as follows.

### Pigment

Cyan pigment dispersion (Pigment Blue 15:3 manufactured by Clariant Co., Ltd.)
White pigment dispersion (“R62N”, manufactured by Sakai Chemical Industry Co., Ltd., titanium oxide)

### Resin Dispersion

Takelac WS-6021 (polyurethane-based resin emulsion, 30% solid content, manufactured by Mitsui Chemicals Polyurethanes, Inc.)

### Moisturizing Agent

### Glycerin

Triethylene glycol

### 1,2-Hexanediol

### Surfactant

BYK-348 (siloxane-based surfactant, manufactured by BYK Japan KK)

### Metal Alkali

Potassium hydroxide

### Organic Alkali

### Triethanolamine

### Examples 1 to 6 and Comparative Examples 1 to 4

### Preparation of Ink Composition

All the materials were mixed according to the composition shown in Table 1, and the mixture was sufficiently stirred, thereby obtaining each ink composition. Moreover, the unit of numerical values in the following Table 1 is % by mass, and the total is 100.0% by mass.

### pH Measurement of Ink Composition

The pH of the prepared ink composition was measured at 20° C. using a pH meter (D-52S, manufactured by Horiba, Ltd.).

### Method of Manufacturing Recorded Matter for Test

As texture, a heavy weight T-shirt (5.6 ounces) manufactured by Printstar was used. In a case of the ink composition (white ink or the like) which was used as a base layer of a color ink, the deposition amount of the ink composition was 200 mg/inch², and in a case of a color ink (cyan ink or the like), the ejection amount was 20 mg/inch². In a case where the above-described ink composition which was used as a base layer of a color ink was attached, the color of the texture used was black, and in a case where the above-described color ink was attached, the color of the texture used was white. After attachment of the ink composition, the resultant product was heated by a heat press at 170° C. for 60 seconds to dry. In a case of using a white ink, since a pretreatment liquid obtained in the following manner was attached to a texture and dried under the following conditions before ink attachment, the ink composition was attached from the top of the texture. Moreover, a printer used to attach the ink composition was an SC-S30650 manufactured by Seiko Epson Corporation.

15% by mass of calcium chloride, 0.1% by mass of a surfactant (trade name “BYK-348”, manufactured by BYK Co., Ltd), 10% by mass of Vinylblan 1245L (trade name, manufactured by Nissin Chemical Industry Co., Ltd.), and ion exchange water (residual part) were mixed together such that the total amount became 100% by mass, whereby the pretreatment agent was obtained. The blending amount of each component was converted as a solid content. The pretreatment liquid was uniformly coated at a deposition amount of 20 g per A4 size by spraying, and the resultant product was dried at 170° C. until water had evaporated.

A portion of the texture on which the ink composition was not attached was cut out, and a portion of the texture on which the ink composition was attached was used in a test.

Moreover, in this specification, pH measurement of an extract was performed on a recorded matter in which the ink composition was attached at a maximum deposition amount with respect to a recording medium. Specifically, the attaching amount of a color ink when manufacturing a recorded matter for test was 20 mg/inch², and the attaching amount of a white ink was 200 mg/inch².

### pH Measurement of Extract

For the pH values defined in the Oeko-Tex Standard 100 enacted by the Oeko-Tex Association, by immersing the recorded matter in water according to the test method, an extract was manufactured, and the pH of the extract was measured by the test method defined in the standard. In the Examples, pH was measured in the general incorporated foundation Nissenken Quality Evaluation Center which is a certification authority.

### Head Clogging

The ink composition was filled into a printer (SC-S30650 manufactured by Seiko Epson Corporation) equipped with a head having 360 nozzles, it was confirmed that all the nozzles discharged normally, the printer was left to stand for the following period of time after standing time in an environment of 40° C./20% RH, and 10 cc of the ink composition was discharged from the head. Then, a discharging test was performed to examine whether the ink composition was discharged normally from each nozzle or not.

A: In the nozzle test after 1 month, all the nozzles discharged normally.
B: In the nozzle test after 3 weeks, all the nozzles discharged normally, however, in the nozzle test after 1 month, a portion of the nozzles did not normally discharge.
C: In the nozzle test after 2 weeks, all the nozzles discharged normally, however, in the nozzle test after 3 weeks, a portion of the nozzles did not normally discharge.
D: In the nozzle test after 2 weeks, a portion of the nozzles did not normally discharge.

### Degradability of Member

An adhesive piece was manufactured by curing approximately 1 g of an epoxy-based adhesive (which was a mixture obtained by mixing EPIKOTE 828 (trade name) which is an epoxy resin manufactured by Shell Oil Co. and VERSAMID 125 (trade name) which is a curing agent manufactured by COGNIS Corporation in the same amount), and the mass thereof was measured (mass before input). Then, the above-described adhesive piece was immersed in the ink composition in a glass container, the container was capped, and was left to stand for six days in an environment of 70° C. After being left to stand, the adhesive piece was taken out, the ink composition was washed out, and the mass (mass after input) was measured. From the mass before input and the mass after input, the mass change ratio was calculated by the following formula. On the basis of the obtained mass change ratio, a degradability of the member was evaluated according to the following evaluation criteria. Moreover, the above-described adhesive piece was the same kind as the adhesive with which the head of the printer and parts of the supply system used in the above-described “Method of Manufacturing Recorded matter for Test” were adhered.

Mass change ratio(%)={(mass after input−mass before input)/mass before input}×100

B: Mass change ratio was 10% or less.
C: Mass change ratio was greater than 10% and 40% or less.
D: Mass change ratio was greater than 40%.

TABLE 1

| | Example | | | | | | Comparative Example | | | |
|---|---|---|---|---|---|---|---|---|---|---|
| | 1 | 2 | 3 | 4 | 5 | 6 | 1 | 2 | 3 | 4 |
| Cyan pigment dispersion | 5 | 5 | 5 | 5 | 5 | 0 | 5 | 5 | 5 | 5 |
| piqment concentration | | | | | | | | | | |
| White pigment dispersion | 0 | 0 | 0 | 0 | 0 | 8 | 0 | 0 | 0 | 0 |
| piqment concentration | | | | | | | | | | |
| Takelac WS-6021 (30% | 22 | 22 | 22 | 22 | 22 | 26 | 22 | 22 | 22 | 22 |
| solid content) | | | | | | | | | | |
| Glycerin | 13 | 13 | 13 | 13 | 13 | 9 | 13 | 13 | 13 | 13 |
| Triethylene glycol | 3 | 3 | 3 | 3 | 3 | 1 | 3 | 3 | 3 | 3 |
| 1,2-Hexanediol | 1 | 1 | 1 | 1 | 1 | 1 | 1 | 1 | 1 | 1 |
| BYK-348 | 0.3 | 0.3 | 0.3 | 0.3 | 0.3 | 0.3 | 0.3 | 0.3 | 0.3 | 0.3 |
| Potassium hydroxide | 0.08 | 0 | 0.05 | 0 | 0 | 0 | 0 | 0.12 | 0.15 | 0 |
| Sodium hydroxide | 0 | 0.08 | 0 | 0 | 0 | 0 | 0 | 0 | 0 | 0 |
| Triethanolamine | 0 | 0 | 0 | 0.7 | 0.3 | 0.2 | 0 | 0 | 0 | 1.0 |
| Ion exchange water | Residual | Residual | Residual | Residual | Residual | Residual | Residual | Residual | Residual | Residual part |
| | part | part | part | part | part | part | part | part | part | |
| Total | 100 | 100 | 100 | 100 | 100 | 100 | 100 | 100 | 100 | 100 |
| Deposition amount of ink | 20 | 20 | 20 | 20 | 20 | 200 | 20 | 20 | 20 | 20 |
| (mg/inch²) | | | | | | | | | | |
| pH of ink composition | 9.6 | 9.7 | 8.9 | 9.1 | 8.9 | 8.5 | 7.8 | 10.2 | 10.5 | 9.4 |
| pH of extract | 6.5 | 6.7 | 5.2 | 7.0 | 6.6 | 7.4 | 5.0 | 7.6 | 7.8 | 7.6 |
| pH of ink composition - pH | 3.1 | 3 | 3.7 | 2.1 | 2.3 | 1.1 | 2.8 | 2.6 | 2.7 | 1.8 |
| of extract | | | | | | | | | | |
| Head clogging | A | A | B | A | B | C | D | B | B | B |
| Degradability of Member | C | C | B | B | B | B | B | B | D | B |

From comparison of each Example and Comparative Example 1, it was found that when the pH of the ink composition was 8.5 or less, the head clogging occurred. In addition, from comparison of each Example and Comparative Examples 2 and 4, it was found that when the pH of an extract was 7.5 or greater, safety required in the Oeko-Tex Standard was poor. Furthermore, from comparison of each Example and Comparative Example 3, it was found that when the pH of the ink composition was 10.4 or greater, the member of the recording apparatus was degraded.

The entire disclosure of Japanese Patent Application No. 2013-221952, filed Oct. 25, 2013 is expressly incorporated by reference herein.

What is claimed is:

1. An ink jet ink composition, comprising:
one or more kinds selected from a group formed of a pigment and a resin dispersion; and
one or more alkali components selected from a group formed of metal alkalis and organic alkalis,
wherein a pH of the ink jet ink composition is 8.5 to 10.4, and
a pH of an extract of a recorded matter for a test in which the ink jet ink composition is attached to a recording medium is 4.0 to 7.5.

2. The ink jet ink composition according to claim 1,
wherein the metal alkali is one or more kinds selected from a group formed of potassium hydroxide, sodium hydroxide, and lithium hydroxide, and
the organic alkali is one or more kinds selected from a group formed of triethanolamine and triethylamine.

3. The ink jet ink composition according to claim 1, which is used in a recording method including drying the recorded matter at 100° C. or higher.

4. The ink jet ink composition according to claim 1,
wherein the recording medium is texture of textile or a knitting.

5. The ink jet ink composition according to claim 1,
wherein the alkali component includes the metal alkali.

6. The ink jet ink composition according to claim 1,
wherein the pH of the ink jet ink composition is 8.7 to 9.5.

7. The ink jet ink composition according to claim 1,
wherein the recording medium is clothes.

8. The ink jet ink composition according claim 7,
wherein the clothes are clothes for infants or clothes which come into direct contact with human skin when being worn.

9. A recording method having attaching the ink jet ink composition according to claim 1 to a recording medium by discharging from an ink jet nozzle.

10. A recording method having attaching the ink jet ink composition according to claim 2 to a recording medium by discharging from an ink jet nozzle.

11. A recording method having attaching the ink jet ink composition according to claim 3 to a recording medium by discharging from an ink jet nozzle.

12. A recording method having attaching the ink jet ink composition according to claim 4 to a recording medium by discharging from an ink jet nozzle.

13. A recording method having attaching the ink jet ink composition according to claim 5 to a recording medium by discharging from an ink jet nozzle.

14. A recording method having attaching the ink jet ink composition according to claim 6 to a recording medium by discharging from an ink jet nozzle.

15. A recording method having attaching the ink jet ink composition according to claim 7 to a recording medium by discharging from an ink jet nozzle.

16. A recording method having attaching the ink jet ink composition according to claim 8 to a recording medium by discharging from an ink jet nozzle.

17. A recorded matter which is recorded by attaching the ink jet ink composition according to claim 1 to a recording medium.

18. A recorded matter which is recorded by attaching the ink jet ink composition according to claim 2 to a recording medium.

19. A recorded matter which is recorded by attaching the ink jet ink composition according to claim 3 to a recording medium.

20. A recorded matter which is recorded by attaching the ink jet ink composition according to claim 4 to a recording medium.
